(19) United States
(12) Patent Application Publication
(10) Pub. No.: US 2011/0171496 A1
(43) Pub. Date: Jul. 14, 2011

(54) LIGHT-POWERED MICROBIAL FUEL CELLS

(76) Inventors: Daniel R. Noguera, Madison, WI (US); Timothy J. Donohue, Madison, WI (US); Marc A. Anderson, Madison, WI (US); Katherine D. McMahon, Madison, WI (US); Isabel Tejedor, Madison, WI (US); Rodolfo E. Perez, Madison, WI (US); Yun Kyung Cho, Madison, WI (US)

(21) Appl. No.: 12/243,650

(22) Filed: Oct. 1, 2008

Related U.S. Application Data
(63) Continuation-in-part of application No. 12/029,187, filed on Feb. 11, 2008.
(60) Provisional application No. 60/889,266, filed on Feb. 10, 2007.

(51) Int. Cl. H01M 8/16

(52) U.S. Cl. 429/2

(57) ABSTRACT

Devices and methods for generating electricity utilizing a light-powered microbial fuel cell that includes a light-admitting reaction chamber containing a biological catalyst, such as a photosynthetic bacteria, in a growth medium, an anode and cathode disposed upon or within the reaction chamber, and a conductive material in electrical communication between the anode and cathode. The anode includes an oxidation catalyst, while the cathode includes a reduction catalyst that is accessible to oxygen gas. Preferably, the devices and methods utilize a single light-admitting chamber within which both cathodic and anodic reactions take place.

### CROSS-REFERENCE TO RELATED APPLICATIONS

This application is a continuation-in-part of U.S. Utility patent application Ser. No. 12/029,187, filed Feb. 11, 2008, which claims the benefit of U.S. Provisional Patent Application No. 60/889,266, filed Feb. 10, 2007, each of which is incorporated herein by reference as if set forth in its entirety.

### STATEMENT REGARDING FEDERALLY SPONSORED RESEARCH OR DEVELOPMENT

This invention was made with United States government support awarded by the following agency: DOD-NAVY Grant Nos. 144-LT10, 144-MC50, 144-QP83 and 144-QL34. The United States government has certain rights in this invention.

### BACKGROUND

Alternative energy sources are being sought to offset society's dependence on fossil fuels. While many of these alternatives may be viable options in the near future, others still require major technological advances before they will make a significant impact on the overall energy budget.

One such viable alternative is solar energy (i.e., sunlight). Harvesting solar energy is a long-term, attractive strategy for meeting the global energy challenge. When compared to fossil fuels, solar energy use is a carbon-neutral process that poses no known threat from pollution or greenhouse gases. Despite these advantages, solar energy provided less than 0.1% of the world's electricity in 2001 (US Department of Energy 2005b).

Microbial fuel cells (MFCs) can be used to harvest solar energy. MFCs convert chemical energy stored in organic materials into electrical energy through a catalytic reaction mediated by photosynthetic organisms and may be an alternative to fossil fuels. With more solar energy striking the Earth in an hour (4.3×10²⁰ J) than all the energy consumed on our planet in a year (4.1×10²⁰ J; US Department of Energy 2005b), and with photosynthetic microbes highly adapted to capture this solar energy, technological advancements in light-powered MFCs has a potential to improve their utility in practical applications. In principle, hydrogen production via water bio-photolysis by cyanobacteria (Melis 2002) or hydrogen production via direct electron transfer to protons by photosynthetic purple non-sulfur bacteria (Gest & Kamen 1949; Koku et al. 2002) provide a source for the development of light-powered MFCs. Consequently, MFC technology is rapidly evolving for electricity generation from renewable resources.

For example, MFCs recently were shown to capture electricity from organic materials in sediments (Bond et al. 2002; Holmes et al. 2004; and Tender et al. 2002), wastewater (Liu et al. 2004; Logan 2005; and Min & Logan 2004) or agricultural wastes (Min et al. 2005). Typical MFC designs include dual-chambered cells in which anodic and cathodic chambers are separated by a proton exchange membrane (Logan et al. 2005; Park et al. 1999; and Rabaey et al. 2003); whereas more recent MFC designs include single-chambered cells in which the anode and cathode are placed within the same chamber, with the cathode in direct contact with the atmosphere (i.e., an air cathode) (Liu et al. 2005; and Liu & Logan 2004). The organisms used in these MFCs included pure cultures (Bond & Lovley 2003; and Bond & Lovley 2005) or mixed microbial communities.

Strategies are also known in which hydrogen produced in MFCs is collected before sending the collected gas to a separate MFC (He et al. 2005a). Likewise, a direct coupling of hydrogen production and electricity generation was also achieved within a MFC. In such a system, the hydrogen produced by an organism reacted at a catalytic anodic surface. Such a direct coupling has been demonstrated with dark fermentations (Niessen et al. 2005), as well as with photo-fermentations (Rosenbaum et al. 2005). More recently, evidence for the presence of nanowires in cyanobacteria has also been presented (Gorby et al. 2006), suggesting the possibility of developing photosynthetic MFCs that do not depend on hydrogen production for electricity generation.

Nevertheless, MFC technology is still in its infancy, since the highest power reported for a MFC (˜5,850 mW/m²; Rosenbaum et al. 2004) is two orders of magnitude lower than the goals for conventional abiotic fuel cells (US Department of Energy 2005a). Consequently, major improvements in choice of photosynthetic organism, bio-compatible reactor configurations and electrodes are needed before any practical application of a MFC is achieved (Logan et al. 2006).

### BRIEF SUMMARY

In a first aspect, the present invention is summarized as a light-powered MFC that includes a single light-admitting reaction chamber containing a photosynthetic organism in a growth medium, an anode that is conductive and catalytically active in electrical and fluid communication with a cathode, both disposed within the reaction chamber. The anode includes an oxidation catalyst, while the cathode includes a reduction catalyst that is accessible to oxygen.

The light-admitting reaction chamber can be constructed from an optically transparent material, such as glass, quartz or plastic. By “optically transparent material,” applicants intend materials that admits sufficient light to energize the culture of photosynthetic organisms. Optionally, the reaction chamber can include a vent for gas produced within the reaction chamber.

The photosynthetic organism is one that produces hydrogen (H₂) and can be a Rhodospirillaceae, Acetobacteraceae, Bradyrhizobiaceae, Hyphomicrobiaceae, Rhodobiaceae, Rhodobacteraceae, Rhodocyclaceae or Comamonadaceae. In particular, the photosynthetic organism can be Rhodobacteraceae, especially R. sphaeroides strain 2.4.1.

The growth medium is a growth medium for photosynthetic organisms and can include a single carbon source, such as succinate, propionate, glucose, or a mixture of carbon sources that can supply additional nutrients or energy to the bacterial culture. In addition, the growth medium can be limited for a fixed nitrogen source, such as ammonia.

The anode can be carbon or graphite. Alternatively, the anode can be optically transparent and therefore can be a support material, such as glass, coated with an oxidation catalyst and a conductant, such as tin oxide, indium tin oxide or combinations thereof. The conductant and catalyst can be transparent, to enhance admission of light into the reaction chamber.

The oxidation catalyst can be platinum; whereas the reduction catalyst can be platinum, a platinum and titanium dioxide mixture, co-tetra-methyl phenylporphyrin (CoTMPP) or iron phthalocyanine (FePc).

The cathode can be carbon or graphite and can be permeable to oxygen gas and nitrogen gas, such as an air cathode.

In a related aspect, the invention is summarized in that a method for making an anode suited for use according to the invention includes the step of depositing an amount of an oxidation catalyst on a transparent conductive support sufficient to generate electricity. In some instances, the anode thus produced can be heated to modulate abrasion resistance.

In another aspect, the present invention is summarized as a method for producing electricity directly from a light-powered MFC that includes the steps of: (1) providing a MFC as described above; and (2) exposing the MFC to light, such as sunlight (i.e., solar energy). The MFC can be maintained under anaerobic and/or ammonia-limited conditions. Because the reaction chamber is a single chamber, the photosynthetic organism can directly release hydrogen in the reaction chamber, in close proximity to the anode. Likewise, the anodic and cathodic reactions take place in the single reaction chamber.

These and other features, objects and advantages of the present invention will become better understood from the description that follows. In the description, reference is made to the accompanying drawings, which form a part hereof and in which there is shown by way of illustration, not limitation, embodiments of the invention. The description of preferred embodiments is not intended to limit the invention to cover all modifications, equivalents and alternatives. Reference should therefore be made to the claims recited herein for interpreting the scope of the invention.

### BRIEF DESCRIPTION OF THE DRAWINGS

FIG. 1 is a schematic diagram of a first embodiment of the invention;

FIG. 2 is a schematic diagram of a second embodiment of the invention;

FIG. 3 is a schematic diagram of a third embodiment of the invention;

FIG. 4 depicts the power density generated in a R. sphaeroides photosynthetic MFC supplied with succinate, propionate or glucose;

FIG. 5 depicts the effect of the spacing between electrodes on MFC power output supplied with propionate. The center of the anode was 12.5, 7.5 or 3.0 cm from the cathode; and

FIG. 6 depicts the effect of anode size on MFC power output. The anodes were 1.25, 2.5 or 5 cm² strips of platinized carbon paper, with their center located 3, 1.7 and 1.1 cm away from the cathode. The carbon source used in these experiments was propionate.

FIG. 7 depicts the effect of dip coating and firing on surface resistance of catalyst-coated windows.

FIG. 8 depicts the effect of dip coating and firing on light transmittance through catalyst-coated windows.

FIG. 9 depicts the effect of dip coating on electrochemical performance (polarization curves)

While the present invention is susceptible to various modifications and alternative forms, exemplary embodiments thereof are shown by way of example in the drawings and are herein described in detail. It should be understood, however, that the description of exemplary embodiments is not intended to limit the invention to the specific forms disclosed, but on the contrary, the intention is to cover all modifications, equivalents and alternatives falling within the spirit and scope of the invention as defined by the appended claims.

### DETAILED DESCRIPTION OF EXEMPLARY EMBODIMENTS

Unless defined otherwise, all technical and scientific terms as used herein have the same meaning as commonly understood by one of ordinary skill in the art to which the invention pertains. Although any methods and materials similar to or equivalent to those described herein can be used in the practice or testing of the present invention, the preferred methods and materials are described herein.

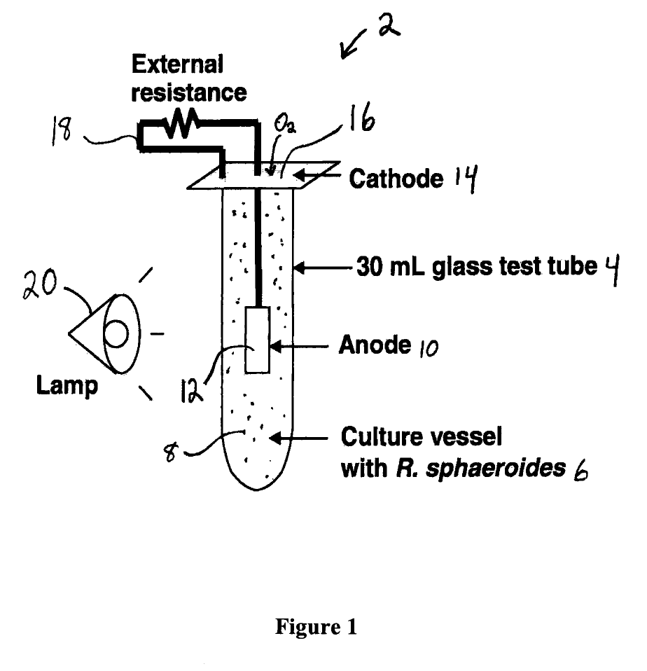

As shown in FIGS. 1-3, a light-powered MFC (2, 30, 40) includes a light-admitting reaction chamber (4, 38, 42) of any suitable geometry, such as a polygon, annulus or sphere. The reaction chamber (4, 38, 42) therefore can have a length, width, depth or circumference, depending upon the geometry. Likewise, the dimensions of the reaction chamber (4, 38, 42) will vary, depending upon the application, as laboratory settings typically require a smaller reaction chamber (4, 38, 42) than industrial settings. In a laboratory setting, such as those described in the Examples, the reaction chamber (4, 38, 42) can have volumes between about 30 ml to about 60 ml. However, in industrial settings, the reaction chamber (4, 38, 42) can have a volume of at least 1 L or more. Regardless, the reaction chamber (4, 38, 42) can be constructed of a material that allows passage of wavelengths of light in the visible to near-infrared region that are used by known or existing families of photosynthetic organisms (i.e., wavelengths from about 600 nm to about 1000 nm). Exemplary materials include, but are not limited to, glass, quartz, plastic and other optically transparent materials that allow passage of wavelengths of light in the near-infrared region. However, as would be understood by one of ordinary skill in the art, the amount and optimal wavelength range of light needed to impinge on the culture will depend upon the photosynthetic organism being utilized within the reaction chamber (4, 38, 42).

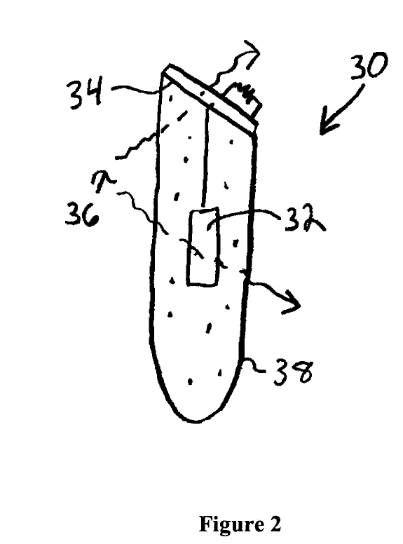

The MFC (2, 30, 40) also includes an anode (10, 32, 46), which is an electrode through which positive electric current flows into (but electrons flow from), disposed within the reaction chamber (4, 38, 42). The anode (10, 32, 46) includes an oxidation catalyst (12) and optionally a conductant (i.e., an electron conductor). The anode (10, 32, 46) can be constructed of a material that is porous, such as carbon, graphite or a thin layer of conductive material coated onto an optically transparent support, such as glass. An optically transparent anode (32) (FIG. 2), however, allows greater amounts of light (36) to pass through the reaction chamber (38). The efficiency of current generation of the MFCs increases when the anode (32) passes wavelengths of light ranging from about 600 nm to about 1000 nm. In a laboratory setting, where reaction chamber (4, 38, 42) volumes can be about 30 ml to about 60 ml, the surface area of the anode (10, 32, 46) can be about 1 cm² to about 10 cm², although one of ordinary skill in the art understands that larger surface areas per unit volume are desired. However, the location of the anode should not hinder light penetration.

The anode (10, 32, 46) includes an oxidation catalyst (12) disposed thereon, which can be a substance that causes or accelerates oxidation without itself being affected, thereby increasing electron transfer. A suitable oxidation catalyst (12) includes platinum, although other platinum metals, such as ruthenium, rhodium, palladium, osmium and iridium, can also be used. For example, the oxidation catalyst (12) can be platinum coated upon carbon paper. Typically, the oxidation catalyst (12) can be small particles of platinum or other catalytic material deposited on a porous electron conductive support (i.e., porous carbon) treated with an ionomer, such as Nafion®. Commercially available platinum-coated anodes, such as those used in the Examples, have small particle of platinum only a few nanometers in diameter, deposited on the surface of carbon pore walls. As such, the layer of catalyst (12) need only be a few nanometers thick, but can be microns thick. The catalyst can be provided on a conductive substrate by repeatedly dip-coating to a thickness sufficient to provide an acceptable surface resistance, such as between about 1Ω and about 100Ω, or between about 18Ω and about 38Ω.

The anode (10, 32, 46) can be coated with the oxidation catalyst (12) though high-temperature methods and low-temperature methods known to one of ordinary skill in the art. Among high-temperature methods are sputtering and oxidation on the anode's (10, 32, 46) surface. Among low-temperature methods are sol-gel processes, liquid phase deposition and direct precipitation on the anode's (10, 32, 46) surface. See also, Park H, et al., “Effective and low-cost platinum electrodes for microbial fuel cells deposited by electron beam evaporation,” Energy Fuels 21:2984-2990 (2007). In addition, the anode (10, 32, 46) can be coated with the oxidation catalyst (12) by tape casting a suspension of platinized carbon.

A cathode (14, 34, 44) is in electrical and fluid communication with the anode (10, 32, 46). The cathode (14, 34, 44) is an electrode through which positive electric current flows out (but electrons flow into), disposed about the reaction chamber (4, 38, 42). The cathode (14, 34, 44) includes a reduction catalyst (16) and optionally a conductant (not shown). For the MFCs described herein, the cathode (14, 34, 44) can be an air cathode that is permeable to oxygen gas and nitrogen gas, but is impermeable to water. The cathode (14, 34, 44) can be constructed of a material that is porous, such as carbon or graphite. In a laboratory setting, where reaction chamber (4, 38, 42) volumes can be about 30 ml to about 60 ml, the surface area of the cathode (14, 34, 44) can be about 1 cm², although one of ordinary skill in the art understands that larger surface areas per unit volume are desired.

As noted above, light penetration through the MFC (2, 30, 40) can be increased by at least two ways, namely, by using an optically transparent reaction chamber (4, 38, 42) with a small diameter or by restricting the size and location of the anode (10, 32, 46) and cathode (14, 34, 44) so that they do not block light penetration. However, light penetration can also be increased by removing the cathode (14, 34, 44) from the internal volume of the reaction chamber (4, 38, 42), such as by sealing the reaction chamber (4, 38, 42) with the catalyst.

The cathode (14, 34, 44) includes a reduction catalyst (16) disposed thereon, which can be a substance that causes or accelerates reduction without itself being affected. Like the oxidation catalyst (12), the reduction catalyst (16) increases electron transfer. A suitable reduction catalyst (16) includes platinum or a platinum and titanium dioxide mixture. For example, the reduction catalyst (16) can be platinum coated upon carbon paper. Likewise, CoTMPP and FePc have recently been shown to be suitable alternatives to platinum in MFCs. Cheng et al. 2006b; and Zhao et al. 2005. In general, the reduction catalyst (16) should be accessible to atmospheric oxygen because the cathode (14, 34, 44) can be an air cathode. Alternatively, oxygen gas evolving from organisms present in the reaction chamber (4, 38, 42) may be reduced in addition to, or in lieu of, atmospheric oxygen.

The cathode (14, 34, 44) can be coated with the reduction catalyst (16), using any of the methods described above with the oxidation catalyst (12).

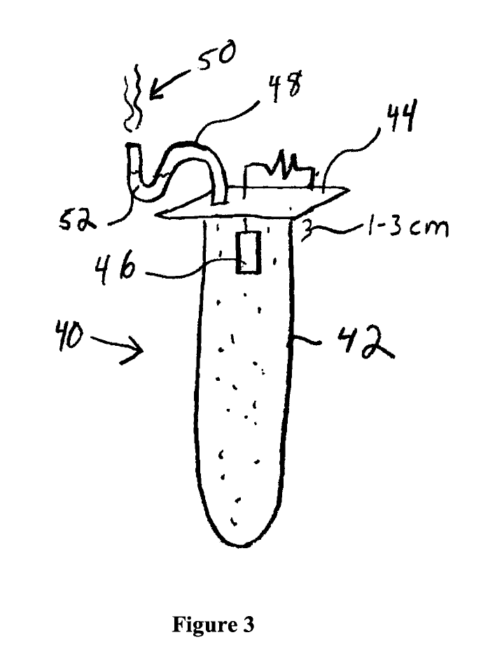

As shown in FIG. 3, the MFC (40) may include a vent (48) that extends from the cathode (44) or the reaction chamber (42) itself (not shown), which permits the emission of gas (50) from the inside of reaction chamber (42). Vent (48), if present, can be of a “S-shaped” variety, which means that a liquid (52) can be disposed within the vent (48) to prevent introduction of external gasses as the gas (50) from the inside of reaction chamber (42) escape to the environment. Preferably, the distance between the anode (46) and cathode (44) in this embodiment is about 1 cm to about 3 cm.

One of ordinary skill in the art, however, understands that the size of the anode (10, 32, 46) and cathode (14, 34, 44), as well as the location of the anode (10, 32, 46) relative to the cathode (14, 34, 44), will vary depending upon the volume of the reaction chamber (4, 38, 42). One of ordinary skill in the art, however, can readily determine these parameters using the teachings described below in the Examples. In general, the greater the distance between the electrodes, the greater the internal resistance of the MFC (2, 30, 40). Therefore, regardless of the size of the reaction chamber (4, 38, 42), the distance between the electrodes should be reduced as much as possible.

The anode and cathode may also include a conductant (not shown), such as, tin oxide, indium tin oxide or a combination thereof. Methods of applying conductants to these electrodes are well-known to one of ordinary skill in the art. See, e.g., U.S. Pat. No. 7,326,399. The conductant can be dispersed between the either catalyst. The layer of conductant need only about a microns or less.

The anode (10, 32, 46) and cathode (14, 34, 44) are in electrical communication via a conductive material (18, 39, 54), such as an assembly of commercially available copper/zinc wires of widths in the range of about 20 to about 30 American wire gauge (AWG) that connect each electrode through a carbon resistor having an electric resistance of 10,000 Ohms. The connections between the conductive material (18, 39, 54) and the electrodes can be of low resistance to prevent power losses in the electron flow and can be isolated using a water-proof, electrical tape such as commercial PVC tape or Kapton tape (CS Hyde; Lake Villa, Ill.). The electrical connection between the electrodes and the wires can be improved, if necessary, by using multiple conductive materials (18, 39, 54) to connect each electrode to the resistor unit, or by the sputtering of a conductive gold layer onto the electrode edges in contact with the wires and unexposed to the growth medium.

The MFC (2, 30, 40) includes a growth medium (8) for culturing and growing the photosynthetic organism (6), as well as providing fluid communication between the anode (10, 32, 46) and cathode (14, 34, 44). The growth medium (8) can be any growth medium for photosynthetic organisms and should have at least a carbon source for generating electrons, nutrients and a pH compatible for such organisms. Suitable growth medium (8) formulations can be chemically defined and should lack potential electron acceptors, nitrates or carbon dioxide, all of which will compete for the electrons needed to support production of hydrogen in the MFC (2, 30, 40). See, Biebl & Pfennig 1981. For example, the growth medium (8) can be any growth medium for photosynthetic organisms known to one of ordinary skill in the art, such as Sistrom's minimal growth medium (Sistrom 1960; and Sistrom 1962). Other suitable growth medium (8) formulations are known to one of ordinary skill in the art and may be used with the MFCs (2, 30, 40) described herein. See, e.g., Bergey's Manual of Systematic Bacteriology.

Although not required, one of ordinary skill in the art can increase hydrogen gas production by using a growth medium (8) with a single carbon source or a more complex medium that contains a plurality of carbon sources, such as wastewater, plant biomass extracts or other feedstocks. Suitable single carbon sources are monosaccharides and organic acids, particularly those organic acids having a carboxyl group, such as monocarboxylic acids and dicarboxylic acids. See, Truper Pfennig 1978. The single carbon source preferably has a low oxidation state (i.e., be highly reduced). Single carbon sources for use with the MFCs (2, 30, 40) described herein include, but are not limited to, succinate, propionate, glucose, pyruvate, malate, butyrate, tartrate, acetate, ethanol and glycerol.

To further increase hydrogen gas production, the growth medium (8) is limited for a fixed nitrogen source. That is, the ammonia in the growth medium (8) can be depleted by the photosynthetic organism (6) or can be replaced with an organic nitrogen source that limits the photosynthetic organism's (6) ability to produce ammonia. Alternatively, the growth medium (8) is essentially free of ammonia. Suitable organic nitrogen sources include, but are not limited to, amino acids such as glutamate and nitrogen gas, as well as any other fixed nitrogen that is transport or assimilated by the photosynthetic organism (6).

The growth medium (8) has a pH between about 3 to about 9, alternatively between about 5 to about 9. However, one of ordinary skill in the art understands that the optimal pH of the growth medium (8) for hydrogen production will vary with the isoelectric point (pI) of the materials used for the electrodes. Likewise, the pH of the growth medium (8) should be compatible with growth, survival or hydrogen production by the photosynthetic organism (6), although it is known that lower pHs may increase current production by traditional abiotic MFCs.

The photosynthetic organism (6) is also in the growth medium (8) and catalyzes the conversion of organic matter in the growth medium (8) into electricity by transferring electrons to a developed circuit and does so by using hydrogen as a reducing agent. One such photosynthetic organism (6) is purple non-sulfur bacteria, especially those from the following families: Acetobacteraceae, Bradyrhizobiaceae, Chromatiaceae, Comamonadaceae, Hyphomicrobiaceae, Rhodobiaceae, Rhodobacteraceae, Rhodocyclaceae, Rhodospirillaceae, as well as other known or existing photosynthetic organisms (6) that produce hydrogen. In addition, a mixture or consortia of these photosynthetic organisms (6) may be used. Of particular interest herein are members of Rhodobacteraceae, especially R. sphaeroides. Suitable R. sphaeroides include strains 2.4.1 (American Type Culture Collection (ATCC); Manassas, Va.; Catalog #BAA-808), 2.4.7 (ATCC; Catalog #17028) or R. capsulatus B10 (ATCC; Catalog #33303). Other photosynthetic organisms (6) include red, blue or green algae, as these organisms are known to produce biohydrogen.

Purple non-sulfur bacteria, such as R. sphaeroides, are efficient at capturing light energy (e.g., solar energy) when grown photosynthetically under anaerobic conditions and in the presence of an external organic substrate (i.e., carbon source). These organisms absorb light within the visible range, and then transform the absorbed light photosynthetically into ATP, generating electrons and protons. The electrons are eventually transferred to a high potential electron acceptor such as oxygen. These metabolic requirements are consistent with the operation of the MFCs (2, 30, 40) described herein, in which the reaction chamber (4, 38, 42) can be anaerobic for the transfer of electrons from the photosynthetic organism (6) to the anode (10, 32, 46), and that an external organic substrate can be provided as an electron donor to induce biological activity that fuels the MFC (2, 30, 40). The main difference with respect to typical MFCs described in the literature and the MFCs (2, 30, 40) described herein is that our reaction chambers (4, 38, 42) allow sufficient light penetration.

Manipulations of the photosynthetic organism (6) are also contemplated, particularly manipulations that increase hydrogen production. When R. sphaeroides generates excess reducing power, it passes the resulting electrons to one of several pathways (Richardson et al. 1988), such as polyhydroxybutyrate synthesis, the Calvin cycle (Paoli et al. 1998; Richaud et al. 1991; and Tichi & Tabita 2001), hydrogen gas evolution (Gest & Kamen 1949), reduction of other electron acceptors (McEwan et al. 1987) or other uncharacterized pathways (Tavano et al. 2005). Therefore, it may be possible to improve MFC (2, 30, 40) function by altering these systems or by isolating strains wherein at least one mutation allows hydrogen gas production even in the presence of a nitrogen source such as ammonia.

For example, one of ordinary skill in the art may remove systems that compete for reducing power, such as carbon dioxide fixation, polyhydroxyalkanoate synthesis or production of soluble metabolites, by altering the systems that produce the hydrogen that powers the MFCs (2, 30, 40) or by eliminating the dependence of ammonia-limiting conditions (Rey et al. 2007). These alterations can be accomplished by genetic manipulation of the photosynthetic organism (6).

In operation, a light source (20, 36) illuminates the reaction chamber (4, 38, 42), causing the photosynthetic organism (6) to oxidize organic substrates, such as the carbon source, and to produce electrons. Electrical current resulting from the oxidation reaction at the anode (10, 32, 46) travels to cathode (14, 34, 44) through conductive material (18, 39, 54) and is then catalytically combined by the reduction catalyst (16) with oxygen and protons to form water at the cathode (14, 34, 44). Thus, the photosynthetic organism (6) functions as a biocatalyst, mediating the degradation of organic materials to produce electrons.

Using single chambered MFCs (2, 30, 40) is important because molecular oxygen is ultimately the preferred electron acceptor. Oxygen diffusing from the cathode (14, 34, 44) (specifically, an air cathode) to the anode (10, 32, 46) dictates the minimum distance necessary between the electrodes. See, Cheng et al. 2006a. In the examples described herein, a negative effect of reducing electrode spacing was not observed. On the contrary, the best MFC performance was obtained when the center of the electrodes was separated by only 1.1 cm. Since the examples used a pure culture of R. sphaeroides, and R. sphaeroides is not know to form biofilms on electrode surfaces to date, oxygen diffusion into the MFCs was likely minimized by aerobic respiration of planktonic R. sphaeroides located near the cathode.

Without intending to be limited as to the theory underlying the present invention, it is believed that the main mechanism of electron transfer from R. sphaeroides to the anode was through in situ oxidation of the hydrogen produced by the culture in the stationary phase, when ammonia became a limiting nutrient. Neither biogas nor electricity was produced during exponential growth. This is consistent with the general use of resting cells of purple non-sulfur bacteria for hydrogen production under ammonia-limited conditions, and observations of the kinetics of hydrogen production in growing cultures (Koku et al. 2003), which showed that hydrogen evolution did not occur until mid-exponential or stationary phase.

The rate of hydrogen production was significantly higher than the rate of in situ hydrogen utilization, and therefore, most of the hydrogen produced was vented from the MFCs. Consequently, a calculation of Coulombic efficiencies was not relevant because most of the hydrogen was vented as a biogas. To increase in situ hydrogen oxidation, one of ordinary skill in the art would typically increase the surface area of the anode per unit of reactor volume. However, the material used in the anode was based on black carbon paper, and therefore, increasing anode surface area would have resulted in a decrease in light penetration with the consequent decrease in light-driven hydrogen production. As such, the anode was made as thin as possible and located in the center of the MFC. Likewise, and from a materials science perspective, improving the efficiency of photosynthetic MFCs required the use of anode materials that allow penetration of the near-infrared light (i.e., optically transparent) needed for photosynthesis by purple non-sulfur bacteria.

The Examples below do not show any evidence for the existence of electron transfer mechanisms other than hydrogen production and its in situ oxidation. That is, there was no observable, direct contact between the cells and anode (i.e., no nanowires were present). Likewise, very little power output (<0.01 mW/m²) was detected when the platinum-coated anode was replaced by a similar-sized piece of plain carbon paper. Moreover, the best performance obtained corresponded to normalized power densities around 700 mW/m² (i.e., 2.9 W/m³ on a volumetric basis). In contrast, MFCs incubated in the dark produced no more than 0.5 mW/m² (i.e., 0.008 W/m³ on a volumetric basis).

In the examples with commercially available platinum-coated carbon paper, we maintained high MFC performance for more than forty-eight hours, without an apparent loss in catalytic activity, thus highlighting the importance of using biocompatible materials for the light-admitting reaction chamber and electrodes in light-powered MFCs.

The invention will be more fully understood upon consideration of the following non-limiting Examples.

### EXAMPLES

### Example 1

### Light-Powered MFCs

Methods.

MFCs. All experiments were conducted in single-chamber MFCs constructed in glass test tubes to facilitate light admittance (FIG. 1). In the simplest configuration, an anode was submerged in a microbial culture, and a cathode sealed the top of the test tube. A slightly modified configuration used in some experiments included a side arm sealed with the cathode, while the top of the test tube was sealed with a rubber stopper. The typical working volumes of these MFCs were between 30 ml and 60 ml.

The anode was a rectangular piece (5 cm², unless noted otherwise) of either platinum-coated phosphoric acid fuel cell electrode on Toray carbon paper (0.35 mg platinum/cm²; E-Tek; Somerset, N.J.) or plain Toray carbon paper (E-Tek) that did not contain platinum. The cathode was also made of platinum-coated Toray carbon paper (1.7 cm²). In most experiments, the anode and cathode were connected through a 10,000 Ohm external resistance.

Biogas produced by the cultures was vented out through a needle placed at the top of the MFCs and connected to a U-shaped tube filled with a liquid (e.g., water or oil) to prevent oxygen from diffusing back into the MFCs. When necessary, sterile Sistrom's minimal medium without any organic carbon source was added to the MFCs to maintain a constant culture volume.

Photosynthetic cultures. Experiments were conducted with R. sphaeroides strain 2.4.1. Prior to electrochemical experiments, the bacteria were grown under anaerobic photosynthetic conditions, using Sistrom's minimal medium containing 50 mM succinate made from a succinic acid salt solution (Thermo Fisher Scientific; Waltham, Mass.) as the sole carbon source. The cultures were placed in front of an incandescent light source (10 W/m², as measured with a Yellow-Springs-Kettering model 6.5-A radiometer through a Corning 7-69, 620 nm to 110 nm filter) and were allowed to grow for ˜2 days, until a typical red pigmentation was observed.

MFC Experiments. To initiate a MFC experiment, 1 ml of the culture was replaced with fresh. Sistrom's minimal medium containing either 50 mM succinate, glucose or propionate as the carbon source, and then, the MFC was connected to the data acquisition system. To test the effect of light on function of the MFC, parallel cultures were pre-grown photosynthetically, and then amended with the carbon source, placed in the dark and monitored for power output.

Electrochemical measurements. A voltage drop across the external resistance (V) was measured and logged at five-minute intervals using a computer-controlled, digital multimeter (DMM PCI-4070; National Instruments; Austin, Tex.) combined with a data input/output card (PCI-6518, National Instruments) and a relay system that facilitated on-line measurements of up to eight MFCs operated in parallel. LabVIEW®-based software (National Instruments) was used as a graphical interface for data handling. The response variables derived from these measurements were current (I) and power (P) generated through the circuit, as well as current and power densities calculated per unit area of anode surface (A), or per unit volume of microbial culture (V_{L}). Current was calculated according to Ohm's law (I=V/R, where R is the external resistance), and power was estimated as P=V²/R.

To generate polarization curves, the external circuits were disconnected, and the MFCs stabilized to an open circuit potential. Next, the external resistance was varied from 100,000 Ohms to 10 Ohms at discrete intervals. At each condition, voltage readings were taken once the voltage drop reached an equilibrium condition, which occurred a few minutes after the replacement of the external resistance. The internal resistance in the MFCs was calculated from the slope of a linear region of the polarization curves (Logan et al. 2006).

Other analytical methods. Ammonium was measured by a salicylate method using a Test N' Tube™ Kit (Hach; Loveland, Colo.). The composition of the biogas was measured by gas chromatography using a Shimadzu GC-8A system equipped with a thermal conductivity detector and a stainless steel column packed with Carbosieve SII (Supelco; Bellefonte, Pa.). Helium was used as a carrier gas, and the temperatures for the injector, column and detector were 150° C., 100° C. and 150° C., respectively.

Results.

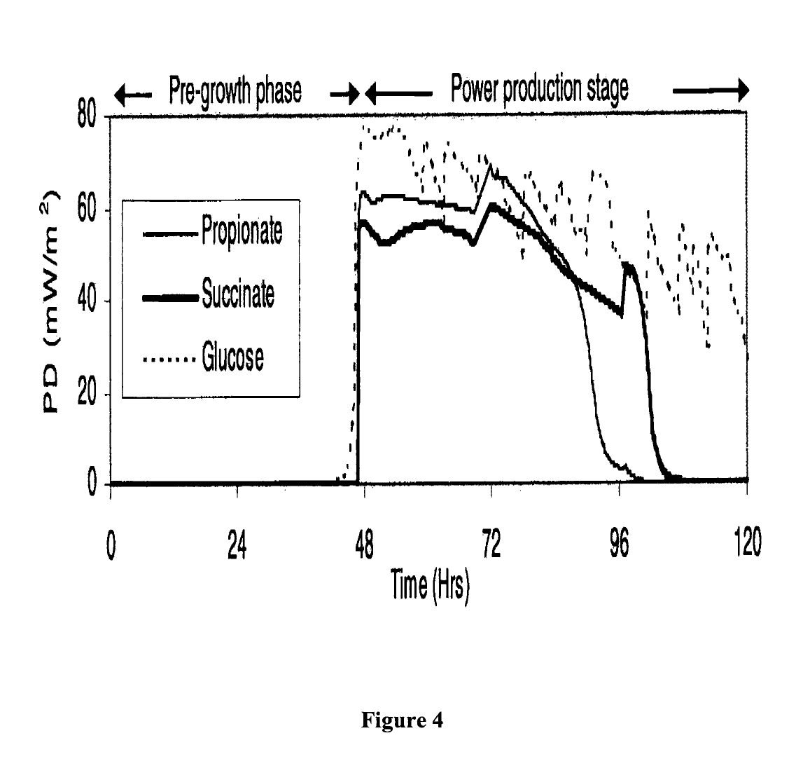

MFC power generation. FIG. 4 shows the results of typical MFC experiments, in which R. sphaeroides was grown photosynthetically on succinate for ˜2 days, and then power generation was measured after the reactor was supplemented with succinate, glucose or propionate. During the initial pre-growth stage, a characteristic red pigmentation developed as the bacteria grew and entered stationary phase. Usually, the power generated during this initial stage was minimal, and therefore, not routinely measured. After the addition of the carbon source to the stationary phase culture, power production and biogas formation within the MFC were observed, suggesting a correlation between biogas formation and electricity generation.

Analysis of the biogas in some MFC experiments indicated that hydrogen and carbon dioxide were the main gases produced, with hydrogen corresponding to 68% to 78% of the total. The power output slightly depended on the type of substrate added to the MFC (FIG. 4). The resulting power density was approximately 55 mW/m² for MFCs supplied with succinate, 60 mW/m² for MFCs supplemented with propionate, and 65 mW/m² for MFCs supplemented with glucose, when the external circuit included a resistor of 10,000 Ohms. These levels of power output were maintained for two to three days, until biogas production diminished. During the period of high power generation, accumulation of biogas immediately below the surface of the cathode correlated with reductions in power, and therefore, the operation of the MFCs required the periodic replacement of the volume occupied by gas with sterile medium, to maintain a good contact between the liquid and the cathode. This reduction in power was eliminated in MFCs in which the cathode was placed on the side arm of the tube, since any biogas accumulation did not interfere with the liquid-cathode contact.

MFCs placed in the dark immediately after the addition of the carbon source to the stationary phase culture resulted in insignificant power densities (less than 0.5 mW/m²) in comparison to the power densities observed when the cultures were exposed to light. In addition, MFC experiments in the dark failed to accumulate biogas, providing further evidence for the connection between biogas production and electricity generation. It is known that light-dependent hydrogen formation occurs in R. sphaeroides and related photosynthetic purple non-sulfur bacteria, and that nitrogenases are one possible source of hydrogen, especially under nitrogen-limited conditions. In these MFC experiments, nitrogen became limiting by the end of the initial growth stage since the ammonium concentration decreased ˜40-fold over this period (from an initial value of 3.8 mM to 0.1 mM), a condition that likely induced nitrogenase-mediated hydrogen formation when the culture received additional organic substrate.

To further explore whether hydrogen oxidation at the anode was the main mechanism of power generation in the R. sphaeroides-based MFCs, we performed light-exposed experiments in which the platinum-coated anode was replaced by a similar-sized piece of plain carbon paper. Under these conditions, the power output was less than 0.01 mW/m² (data not shown), which is insignificant compared with the power densities obtained when the anode was coated with platinum. Based on the observations that hydrogen gas was a major component of the biogas produced in these MFCs, that the increase in power density coincided with the onset of biogas production, and that power generation required the presence of a catalyst on the anode, there is strong evidence to conclude that in situ hydrogen oxidation was the major source of electrons for these light-powered MFCs.

Effect of MFC configuration on power output. To investigate the range of power densities achievable with the R. sphaeroides-based MFCs, experiments were conducted with varying distances between the electrodes and with electrodes differing in anode size. In single-chamber MFCs, the distance between the anode and the cathode significantly affected power output. When the electrodes are too far apart, ohmic losses restrict performance, but when they are placed too close, MFC performance can be compromised if oxygen diffusing through the cathode reaches the anode (Cheng et al. 2006a). Consequently, experiments were conducted in which the anode was placed at different distances from the cathode.

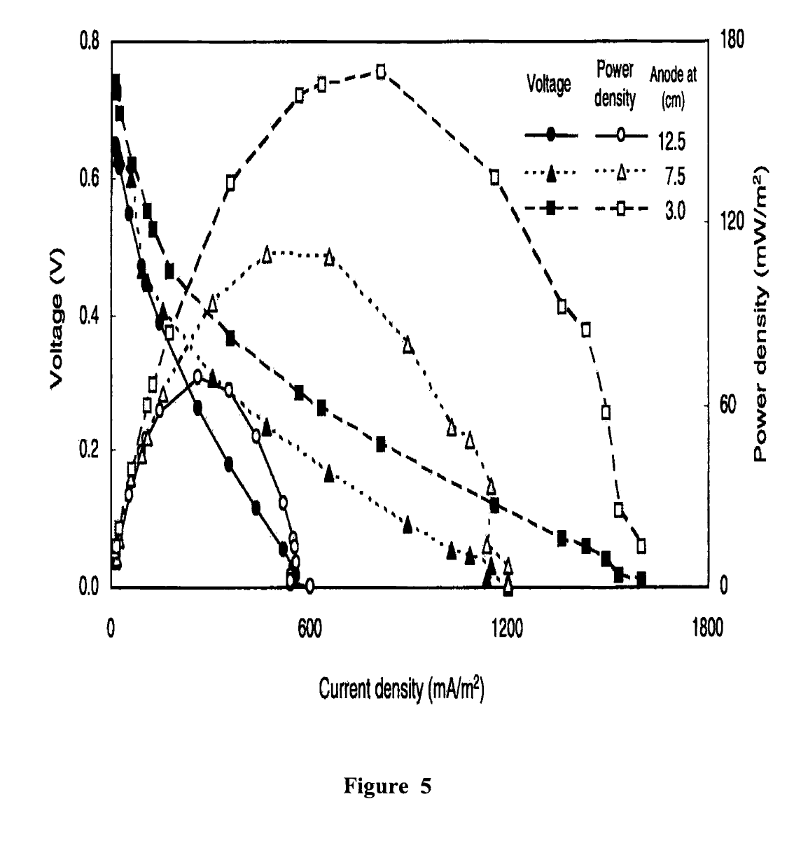

The polarization curves presented in FIG. 5 demonstrate increased power generation as the spacing between the electrodes was reduced, with a maximum power point density of 170 mW/m² obtained when the spacing between the center of the electrodes was 3 cm and the external resistance was 510 Ohms. On a volumetric basis, the maximum power density in this configuration was 2.8 W/m³. The gain in power output can be attributed to the decrease in the internal resistance as the spacing between electrodes was reduced. Since the shape of the polarization curves in FIG. 5 shows a clear differentiation between the slopes representative of the activation and ohmic losses (Logan et al. 2006), the internal resistance in each MFC was calculated from the slope of the linear region representing the ohmic losses. Thus, for the configuration with the largest distance between electrodes (i.e., center of electrodes was 12.5 cm apart) the internal resistance was calculated to be 1,750 Ohms, but with the smallest distance between electrodes (i.e., center of the electrodes was 3 cm apart), the internal resistance was calculated to be 510 Ohms.

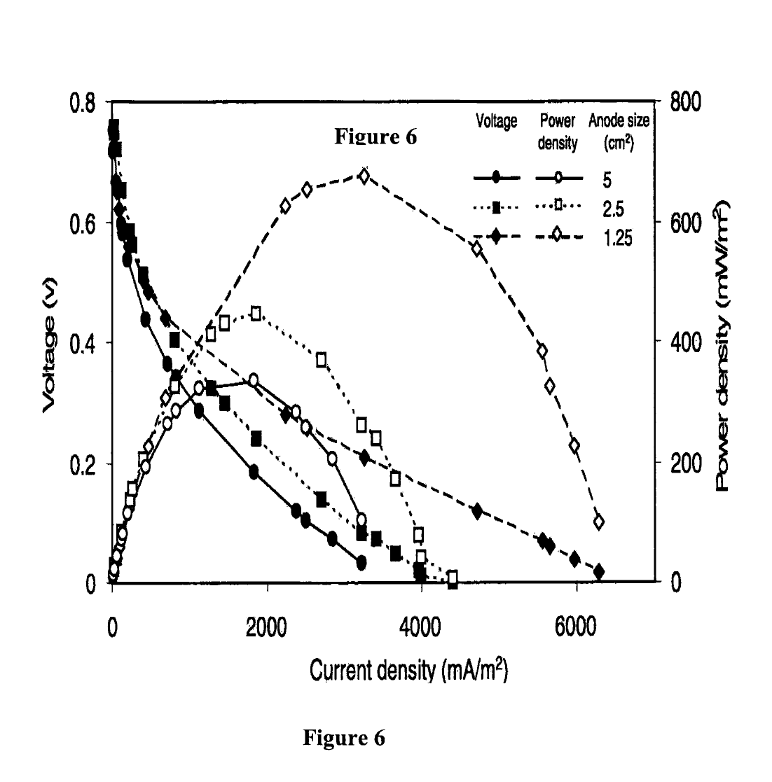

The relative ratio of anode to cathode surface area also affects power generation in other MFCs (Oh & Logan 2006). The effect was demonstrated in dual chamber MFCs, where the surface area of the proton exchange membrane also had a significant impact on power output (Oh & Logan 2006). However, the effect of the surface area ratio in single chamber MFCs with air cathodes and without a proton exchange membrane has not been reported. Thus, to explore the impact of the anode to cathode surface area ratio in the power output of the single chamber light-powered MFCs, we performed experiments with anodes having surface areas of 1.25 cm², 2.5 cm² or 5 cm², while maintaining the surface area of the cathode constant (FIG. 6).

In this example, the spacing between electrodes was kept as small as possible to minimize ohmic losses, as described in FIG. 5. FIG. 6 shows that the maximum point power density in the light-powered MFCs increased as the size of the anode was reduced, suggesting that the anodic reaction was not the limiting step in these devices. The combination of the smallest anode surface and the shortest distance between the electrodes produced the best power density outputs observed so far with any light-powered MFC. The maximum power density point obtained was 700 mW/m², which occurred with an external resistance of 510 Ohms. On a volumetric basis, this maximum output was 2.9 W/m³. In addition, the internal resistance in this MFC was reduced to 130 Ohms (based on the slope of the polarization curve), which was an improvement over the internal resistance calculated from the experiments shown in FIG. 3. These internal resistance values are orders of magnitude higher than observed in optimized MFC configurations (Cheng et al. 2006a; He et al. 2005b), suggesting that power output in light-powered MFCs could be enhanced with next generation designs that maximize proton mass transport.

The above experiments demonstrate that it is possible to operate single-chambered MFCs that capture solar energy and simultaneously utilize organic renewable resources. In our single-chambered MFCs, hydrogen was produced by R. sphaeroides and oxidized in situ on an anodic surface containing platinum as the catalyst. To close the circuit, an air cathode catalyzed the reduction of atmospheric oxygen. In the initial MFC designs presented here, the rate of in situ hydrogen oxidation was much lower than the rate of hydrogen production, and therefore, most of the biogas produced was vented out of the system. In situ hydrogen oxidation could be maintained for up to forty-eight hours, without any evidence of inhibition of the electrocatalytic anodic reactions.

### Example 2

### Abiotic MFCs Having Optically Transparent Electrodes

Methods.

MFCs. MFCs were constructed as described in Example 1; however, the MFCs had each had a different anode material: (1) platinum-coated phosphoric acid fuel cell electrode on Toray carbon paper (i.e., positive control), (2) indium tin oxide (Cardinal Glass; Spring Green, Wis.) coated on glass, (3) tin oxide (Cardinal Glass) coated on glass, (4) indium tin oxide coated on glass with a layer of titanium dioxide and platinum, and (5) tin oxide coated on glass with a layer of titanium dioxide and platinum.

Each anode had an approximate area of ˜1 cm². Briefly, the MFCs were assembled in modified test tubes with a side window made to host a cathode. The anodes were immersed in a citric acid-phosphate buffer solution (pH ˜7). Copper tape (3M; St. Paul, Minn.) was used to enhance the area of contact between the anode and the conducting wire. The tape surrounded the top of the anode with the wire inserted in between layers of tape. This copper-based contact was then covered with insulating Kapton tape.

MFC experiments. Once the systems were assembled, hydrogen gas was delivered through a needle into the solution, to ensure hydrogen availability. The MFCs were evaluated sequentially, using the same peristaltic pump to ensure similar hydrogen flow rates. Voltage drop across a 10 kΩ resistor was measured before and during hydrogen application to each of the MFCs. The MFCs were tested under light and dark conditions.

The influence of pH on MFC performance was evaluated with the indium tin oxide anode. The MFC was modified so that the clip was replaced by conductive tape covered by insulating Kapton tape. The MFC was filled with three buffers of varying pH (3, 5 and 7). Voltage drop across a 10 kΩ resistor was measured as follows: (1) prior to hydrogen gas bubbling (2) during hydrogen gas bubbling under light conditions (3) during hydrogen gas bubbling under dark conditions, and (4) after stopping hydrogen gas bubbling.

Results.

Effect of anode materials. Table 1 summarizes the voltage drop measured with the different anode materials. No significant voltage drop (i.e., less than 10 mV) was detected before starting the hydrogen bubbling. Platinized tin oxide and indium tin oxide showed promise as a material for optically transparent anodes, although its performance was lower than the platinum-coated, carbon anode. On the other hand, the tin oxide-coated glass anode did not produce any significant current flowing across the resistor. The indium tin oxide-coated glass produced some voltage drop, but at significantly lower levels than the platinum-coated anodes.

TABLE 1
Voltage Drop (in mV) in abiotic MFCs Having Different Anode Materials.

| | Voltage drop during hydrogen |
|---|---|
| Anode Material | gas production (mV) |
| Platinum (positive control) | 760 |
| Indium tin oxide | 102 |
| Tin oxide | ~0 |
| Indium tin oxide + platinum + titanium | 441 |
| dioxide | |
| Tin oxide + Platinum + titanium dioxide | 607 |

The indium tin oxide-coated anode had a power density that was somewhat lower than the positive control; whereas the tin oxide-coated anode showed negligible hydrogen generation. Both the indium tin oxide-coated anode with a layer of titanium dioxide and platinum, and the tin oxide coated-anode with a layer of titanium dioxide and platinum had a power density that was an order of magnitude lower than the positive control.

Effects of pH on MFCs. There was an important effect of pH on MFC, and no effect of light. The effect of pH changes could be related with surface charge. The pI of indium tin oxide is ˜7.5, thus a less negative charge given by increasing pH might be necessary for enhancing its anodic performance. Table 2 summarizes the voltage drop of the indium tin oxide MFC at various pHs.

TABLE 2
Voltage Drop (in mV) in abiotic MFCs Exposed to Different pHs.

| | Before hydrogen gas | During hydrogen gas | After hydrogen gas |
|---|---|---|---|
| pH | (mV) | (mV) | (mV) |
| 3 | 4.07 | 14.6 | 7.3 |
| 5 | 7.5 | 52.3 | 11.2 |
| 7 | 0.1 | 115.5 | 7.3 |

The above experiments demonstrate that optically transparent electrodes are feasible for use with the MFCs described herein, that indium tin oxide by itself has conductive and reactive properties, that adding platinum to optically transparent electrodes improves their reactivity, and that indium tin oxide and tin oxide are suitable materials for optically transparent electrodes when platinum is used as a catalyst. Moreover, the above experiments demonstrate that the reaction in the MFCs is influenced by pH and may be related to the pI of the anode.

### Example 3

### MFCs Having Optically Transparent Electrodes

Methods.

MFCs. MFCs were constructed as described in Example 2.

Photosynthetic cultures. R. sphaeroides strain 2.4.1 was used as the biological catalyst, as described in Example 1. However, ammonia present in the medium was replaced with an equimolar amount of glutamate.

MFC Experiments. MFC experiments were performed as described in Example 1.

Electrochemical measurements. Electrochemical measurements were performed as described in Example 1.

Results.

MFC power generation. The bacteria cells grew and were not inhibited by the materials used to construct the electrodes, as evidenced by hydrogen gas production. These results indicate that the MFCs having optically transparent electrodes are indeed bio-compatible.

Effect of anode materials. The results obtained in these experiments were similar to those in Example 2. The indium tin oxide-coated glass anode showed promise as a material for optically transparent anodes, and the tin oxide-coated glass anode did not produce any significant current flowing across the resistor. When either the indium tin oxide or tin oxide anodes were coated with a thin layer of platinum/titanium dioxide, they performed similarly, with peak voltages between 70 and 80 mV. These power densities, however, where an order of magnitude lower than the positive control, which is consistent with the results obtained in Example 2.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

### Example 4

### A Method for Preparing and Testing Anode

Methods.

Surface Preparation. Borosilicate glass slides rendered conductive on one surface with Indium Tin Oxide (ITO, Delta Technologies, Stillwater, Minn.) had a surface resistance of 4-10 Ω/cm. The slides were cut into approximately 5×3 cm rectangular shapes (or “windows”) that were soaked overnight in 1N HNO₃, then for approximately 2 hours in acetone, and then rinsed in 18 MW deionized water. A portion of each conductive surface was designated for use as an electron conductor. On each window, adhesive tape was applied to protect the designated portion and the non-conductive surface from further treatment.

To deposit catalyst layers, the windows were dip-coated in triplicate 0-, 1-, 4- or 8 times in a platinated titanium dioxide sol of pH 1.55. The particle concentration in the sol was approximately 20 g/L. The platinum concentration in the particles was about 17% with the rest being titanium dioxide. Stable platinum-doped TiO₂ nanoparticulate suspensions can be prepared with platinum loading raging between less than about 1% to about 25%. Dipping was performed for about 30 seconds and then were retracted at approximately 1 mm/second. Between dips, the windows were dried at room temperature for 5 minutes and then at 80° C. for 30 minutes. The adhesive tape was removed and some of the coated windows were fired. During firing, the temperature was increased 10° C. per minute from room temperature to about 200° C. at which the windows were held for 1 hour. Windows having 4 dip-coated layers were fired at 250° C. To evaluate the effect of firing on the conductive substrate, the O-dip conductive window was also fired at 250° C. In general, firing increases surface resistance, as nanoparticles tend to consolidate and form films. However, increased firing temperature also strengthens the catalytic layer against mechanical and chemical stresses, such as scratches or the impact of acids.

Surface resistance. Before and after firing, the windows were placed in an N₂-flushed chamber at approximately 0% humidity to prevent conductivity generated by ion movement. To measure surface resistance, a dedicated probe, belonging to a Trek 152 surface resistance meter (Trek, Inc., Medina, N.Y.) was connected to a multimeter (Fluke). This setup allowed measuring low resistance values, as opposed to the Trek 152 device, which is designed to measure resistance on insulators. Measurements were performed in a chamber flushed with N₂ gas to reduce interferences due to humidity. Four measurements were taken on each slide, each taken in duplicate. For the first reading before and after firing, both poles were placed over catalyst-coated portions of the surface. For the second reading before and after firing, one pole was placed on a catalyst-coated portion, while the other pole was placed on an ITO-coated, catalyst-free conductive portion.

Light transmittance. To determine the effect of the number of dip coatings and firing on visible light transmittance, transmittance was measured twice at between about 400-700 nm before and after firing, such that four measurements were taken on each slide. A borosilicate glass slide (Fisher) was used as blank.

Electrochemical performance. To determine the effect of the number of dip coatings on electrochemical performance, windows were tested in fuel cells supplied with dissolved hydrogen. The fuel cell chamber was filled with deionized water adjusted to pH=2 with HNO₃. Before passing this solution through the fuel cell, the solution was saturated with hydrogen. Polarization curves were recorded using a Reference 600 Potentiostat (Gamry Instruments) set to the galvanic mode.

Results.

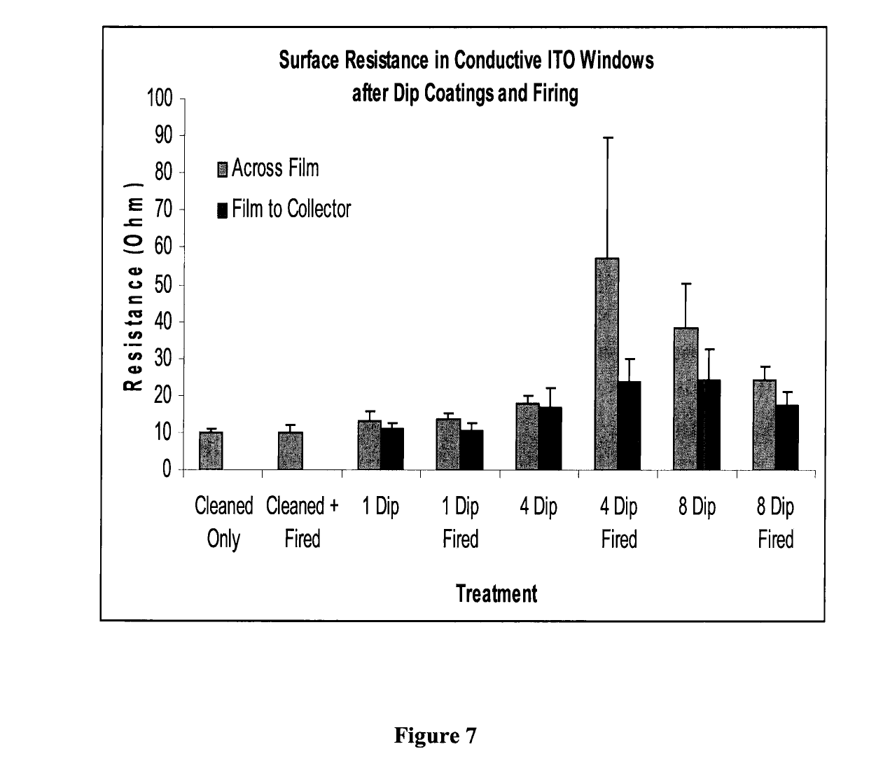

Effects of the number of coatings and firing on surface resistance. The resistance of ITO-coated conductive windows was 10Ω and was unaffected by firing (FIG. 7). The surface resistance of anodes having a single catalyst dip-coat layer did not change relative to that of the catalyst-free conductive windows. However, before firing, the surface resistance of anodes having 4- or 8 catalyst dip coats increased significantly to 18Ω and 38Ω, respectively (FIG. 7; p=0.0002). Firing did not affect surface resistance of anodes having a single catalyst dip coat, but firing at 250° C. increased the surface resistance of anodes having 4 catalyst dip coats, suggesting that firing-induced morphological changes were responsible for the increased resistance. In contrast, firing at 200° C. decreased surface resistance of anodes having 8 catalyst dip coats compared to the same anodes before firing (FIG. 7; p=0.002). Importantly, anodes fired at 250° C. had higher mechanical resistance than anodes fired at 200° C. This could have a beneficial effect on durability.

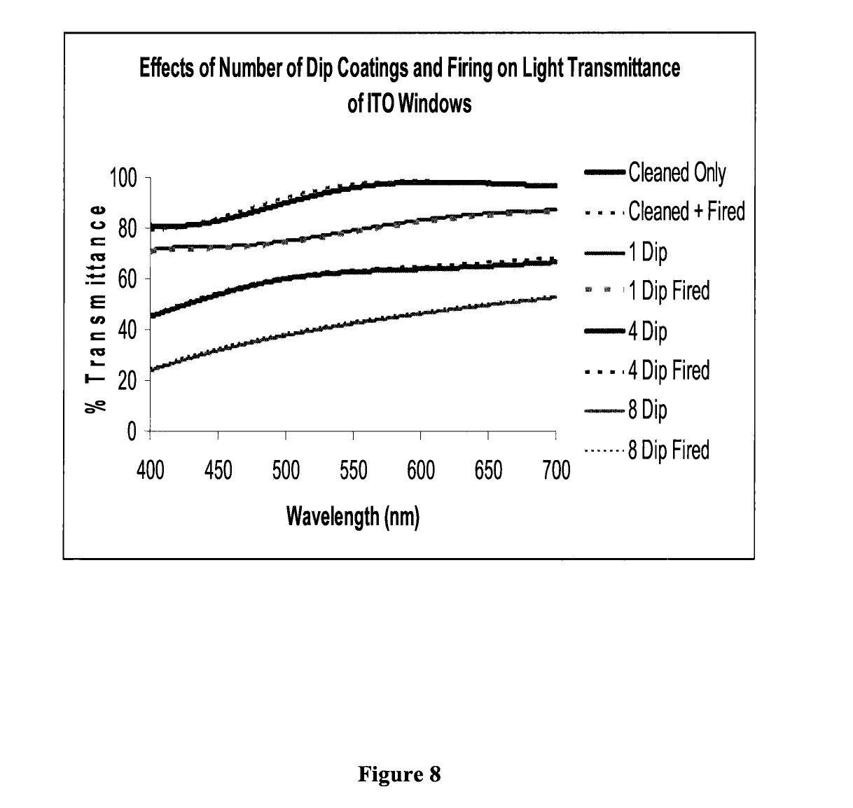

Effects of the number of coatings and firing on light transmittance. Catalyst-free, conductive windows exhibited 92% average light transmittance, while anodes having 4 or 8 catalyst dip coats exhibited 60% and 41% transmittance, respectively. Firing had no measurable effect on light transmittance (FIG. 8).

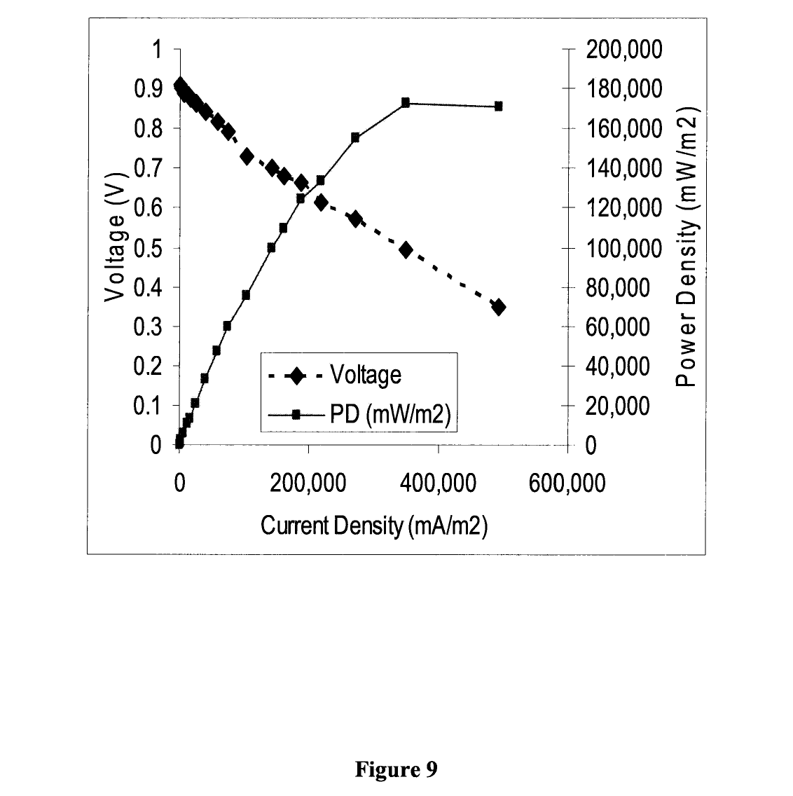

Effects of the number of coatings on electrochemical performance. Anodes having 4 or 8 catalyst dip coats readily catalyzed the oxidation of dissolved hydrogen (FIG. 9), but oxidation was minimal using anodes having only 1 catalyst dip coat. This suggests a direct relationship between electrochemical performance and catalyst coating thickness. The current densities for all three anodes tested were low, which may be attributed to hydrogen's low water solubility.

### Example 5

### Operation of Anode in a Microbial Fuel Cell

Methods.

Microbial fuel cells. Photosynthetic MFC were constructed as described in Example 2, but anodes were constructed as described in Example 4.

MFC experiments. MFC experiments were conducted as described in Example 1. Electrochemical measurements were taken using the setup detailed in Example 4. Two anodes having 4 catalytic layers and one containing 8 layers were tested.

Results.

MFC power generation. Although the tested MFC did not sustain anaerobic cell growth, mainly due to oxygen diffusion from the cathode into the fuel cell chamber, polarizations were obtained by inserting H₂-producing cell cultures into the chambers and taking immediate electrochemical measurements. As in shown in FIG. 9, the power output was higher in anodes having 4 layers, which can be attributed to the higher firing temperature and resultant higher mechanical resistance. Visual inspection of the anodes evidenced catalyst loss from the surface of anodes having 8 layers.

### REFERENCES

All documents cited are incorporated herein by reference as if set forth in their entirety.
Biebl H & Pfennig N, “Isolation of members of the family Rhodospirillaceae,” The Prokaryotes 167-273 (Starr M, et al., eds., New York: Springer 1981).
Blankenship R, et al., “Anoxygenic Photosynthetic Bacteria.” (Kluwer Academic Publishers, Boston 1995).
Bond D, et al., “Electrode-reducing microorganisms that harvest energy from marine sediments,” Science 295:483-485 (2002).
Bond D & Lovley D, “Electricity production by Geobacter sulfurreducens attached to electrodes,” Applied and Environmental Microbiology 69:1548-1555 (2003).
Bond D & Lovley D, “Evidence for involvement of an electron shuttle in electricity generation by Geothrix fermentans,” Applied and Environmental Microbiology 71:2186-2189 (2005).
Cheng S, et al., “Increased power generation in a continuous flow MFC with advective flow through the porous anode and reduced electrode spacing,” Environmental Science & Technology 40:2426-2432 (2006a).
Cheng S, et al., “Power densities using different cathode catalysts (Pt and CoTMPP) and polymer binders (Nafion and PTFE) in single chamber microbial fuel cells,” Environmental Science & Technology 40:364-369 (2006b).
Gest H & Kamen M, “Photoproduction of molecular hydrogen by Rhodospirillum rubrum.”Science 109:558-559 (1949).
Gorby Y, et al., “Electrically conductive bacterial nanowires produced by Shewanella oneidensis strain MR-1 and other microorganisms,” Proceedings of the National Academy of Sciences of the United States of America 103:11358-11363 (2006).
He D, et al., “Hydrogen photosynthesis by Rhodobacter capsulatus and its coupling to a PEM fuel cell,” Journal of Power Sources 141:19-23 (2005a).
He Z, et al., “Electricity generation from artificial wastewater using an upflow microbial fuel cell,” Environmental Science & Technology 39:5262-5267 (2005b).
Holmes D, et al., “Microbial communities associated with electrodes harvesting electricity from a variety of aquatic sediments,” Microbial Ecology 48:178-190 (2004).
Kim J, et al., “Evaluation of procedures to acclimate a microbial fuel cell for electricity production,” Applied Microbiology and Biotechnology 68:23-30 (2005).
Kim M, et al., “Comparison of H-2 accumulation by Rhodobacter sphaeroides KD131 and its uptake hydrogenase and PHB synthase deficient mutant,” International Journal of Hydrogen Energy 31:121-127 (2006).
Koku H, et al., “Aspects of the metabolism of hydrogen production by Rhodobacter sphaeroides,” International Journal of Hydrogen Energy 27:1315-1329 (2002).
Koku H, et al., “Kinetics of biological hydrogen production by the photosynthetic bacterium Rhodobacter sphaeroides OU 001,” International Journal of Hydrogen Energy 28:381-388 (2003).
Lane N, “What can't bacteria do?,” Nature, 441:274-277 (2006.).
Liu H, et al., “Production of electricity from acetate or butyrate using a single-chamber microbial fuel cell,” Environmental Science & Technology 39:65.8-662 (2005).
Liu H & Logan B, “Electricity generation using an air-cathode single chamber microbial fuel cell in the presence and absence of a proton exchange membrane,” Environmental Science & Technology 38:4040-4046 (2004).
Liu H, et al., “Production of electricity during wastewater treatment using a single chamber microbial fuel cell,” Environmental Science & Technology 38:2281-2285 (2004).
Logan B, “Generating electricity from wastewater treatment,” Water Environment Research, 77:211-211 (2005).
Logan B, et al., “Microbial fuel cells: methodology and technology,” Environmental Science & Technology 40:5181-5192 (2006).
Logan B, et al., “Electricity generation from cysteine in a microbial fuel cell,” Water Research 39:942-952 (2005).
McEwan A, et al., “The periplasmic nitrate reductase of Rhodobacter capsulatus: purification, characterization and distinction from a single reductase for trimethylamine-N-oxide, dimethylsulfoxide and chlorate,” Archives of Microbiology 147:340-345 (1987).
Melis A, “Green alga hydrogen production: progress, challenges and prospects,” International journal of Hydrogen Energy 27:1217-1228 (2002).
Min B, et al., “Electricity generation from swine wastewater using microbial fuel cells,” Water Research 39:4961-4968 (2005).
Min 13 & Logan B, “Continuous electricity generation from domestic wastewater and organic substrates in a flat plate microbial fuel cell,” Environmental. Science & Technology 38:5809-5814 (2004).
Nandi R & Sengupta S, “Microbial production of hydrogen: an overview,” Critical Reviews in Microbiology 24:61-84 (1998).
Nath K & Das D, “Improvement of fermentative hydrogen production: various approaches,” Applied Microbiology and Biotechnology 65:520-529 (2004).
Niessen J, et al., “Gaining electricity from in situ oxidation of hydrogen produced by fermentative cellulose degradation,” Letters in Applied Microbiology 41:286-290 (2005).
Niessen J. et al., “Exploiting complex carbohydrates for microbial electricity generation—a bacterial fuel cell operating on starch,” Electrochemistry Communications 6:955-958 (2004).
Oh S & Logan B, “Proton exchange membrane and electrode surface areas as factors that affect power generation in microbial fuel cells,” Applied Microbiology and Biotechnology 70:162-169 (2006).
Paoli G, et al., “Physiological control and regulation of the Rhodobacter capsulatus cbb operons,” Journal of Bacteriology 180:4258-4269.
Park D, et al., “Microbial utilization of electrically reduced neutral red as the sole electron donor for growth and metabolite production,” Applied and Environmental Microbiology 65:2912-2917 (1999).
Park D & Zeikus J, “Improved fuel cell and electrode designs for producing electricity from microbial degradation,” Biotechnology and Bioengineering 81:348-355 (2003).
Phung N, et al., “Analysis of microbial diversity in oligotrophic microbial fuel cells using 16S rDNA sequences,” Ferns Microbiology Letters 233:77-82 (2004).
Rabaey K, et al., “Microbial phenazine production enhances electron transfer in biofuel cells,” Environmental Science & Technology 39:3401-3408 (2005).
Rabaey K, et al., “Biofuel cells select for microbial consortia that self-mediate electron transfer,” Applied and Environmental Microbiology 70:5373-5382 (2004).
Rabaey K, et al., “A microbial fuel cell capable of converting glucose to electricity at high rate and efficiency,” Biotechnology Letters 25:1531-1535 (2003).
Rabaey K & Verstraete W, “Microbial fuel cells: novel biotechnology for energy generation,” Trends in Biotechnology 23:291-298 (2005).
Reguera G, et al., “Extracellular electron transfer via microbial nanowires.” Nature 435:1098-1101 (2005).
Rey F, et al., “Redirection of metabolism for biological hydrogen production,” Appl. Environ. Microbiol. 73:1665-1671 (2007).
Richardson D, et al., “The role of auxiliary oxidants in maintaining redox balance during phototrophic growth of Rhodobacter capsulatus on proprionate or butyrate,” Archives of Microbiology 150:131-137 (1988).
Richaud P, et al., “Identification and sequence analysis of the hupR1 gene, which encodes a response regulator of the NtrC family required for hydrogenase expression in Rhodobacter capsulatus,” Journal of Bacteriology 173:5928-5932 (1991).
Rosenbaum M, et al., “In situ electrooxidation of photobiological hydrogen in a photobioelectrochemical fuel cell based on Rhodobacter sphaeroides,” Environmental Science & Technology 39:6328-6333 (2005).
Schroder U, et al., “A generation of microbial fuel cells with current outputs boosted by more than one order of magnitude,” Angewandte Chemie-International Edition 42:2880-2883 (2003).
Sistrom W, “A requirement for sodium in the growth of Rhodopseudomonas sphaeroides,” Gen Microbiol. 22:778-785 (1960).
Sistrom W, “The kinetics of the synthesis of photopigments in Rhodopseudomonas sphaeroides,” J. Gen. Microbiol. 28:607-616 (1962).
Tavano C, et al., “Gene products required to recycle reducing power produced under photosynthetic conditions,” J. Bacteriol. 187:5249-5258 (2005).
Tender L, et al., “Harnessing microbially generated power on the seafloor,” Nature Biotechnology 20:821-825 (2002).
Thiele J, et al., “Control of interspecies electron flow during anaerobic-digestion—role of floc formation in syntrophic methanogenesis,” Applied and Environmental Microbiology, 54:10-19 (1988).
Tichi M & Tabita F, “Interactive control of Rhodobacter capsulatus redox-balancing systems during phototrophic metabolism,” Journal of Bacteriology 183:6344-6354 (2001).
Truper H & Pfennig N, “The photosynthetic bacteria,” 19-30 (Clayton R & Sistrom W, Eds. Plenum Press, New York 1978).
Ueno Y, et al., “Microbial community in anaerobic hydrogen-producing microflora enriched from sludge compost,” Applied Microbiology and Biotechnology 57:555-562 (2001).
US Department of Energy, “Annual progress report—fuel cells,” (2005a) (available on the US Dept. of Energy website).
US Department of Energy, “Basic research needs for solar energy utilization,” (2005b) (available on the Office of Basic Energy Sciences website).
Yagishita T, et al., “Performance of photosynthetic electrochemical cells using immobilized Anabaena variabilis M-3 in discharge/culture cycles,” Journal of Fermentation and Bioengineering 85:546-549 (1998).
Yokoi H, et al., “Microbial hydrogen production from sweet potato starch residue,” Journal of Bioscience and Bioengineering 91:58-63 (2001).
Zhao F, et al., “Application of pyrolysed iron (II) phthalocyanine and CoTMPP based oxygen reduction catalysts as cathode materials in microbial fuel cells,” Electrochem. Commun. 7:1405-1410 (2005).
Zhao F, et al., “Challenges and constraints of using oxygen cathodes in microbial fuel cells,” Environmental Science & Technology 40:51.93-5199 (2006).
ZUrrer H & Bachofen R, “Hydrogen Production by the Photosynthetic Bacterium Rhodospirillum-Rubrum,” Applied and Environmental Microbiology 37:789-793 (1979).

What is claimed is:

1. A light-powered microbial fuel cell, comprising:
a light-admitting reaction chamber containing a photosynthetic organism in a growth medium, wherein the light-admitting reaction chamber is a single reaction chamber;
an anode disposed within the reaction chamber, the anode having an oxidation catalyst disposed thereon; and
a cathode in fluid and electrical communication with the anode, wherein the cathode includes a reduction catalyst disposed thereon that is accessible to oxygen gas.

2. The microbial fuel cell of claim 1, wherein the light-admitting reaction chamber comprises a material selected from the group consisting of glass, quartz and plastic.

3. The microbial fuel cell of claim 1, wherein the light-admitting reaction chamber further comprises a vent for emitting a gas produced within the reaction chamber.

4. The microbial fuel cell of claim 1, wherein the photosynthetic organism is a member selected from the group consisting of Rhodospirillaceae, Acetobacteraceae, Bradyrhizobiaceae, Hyphomicrobiaceae, Rhodobiaceae, Rhodobacteraceae, Rhodocyclaceae and Comamonadaceae.

5. The microbial fuel cell of claim 4, wherein the Rhodobacteraceae is Rhodobacter sphaeroides.

6. The microbial fuel cell of claim 4, wherein the Rhodobacteraceae is Rhodobacter sphaeroides strain 2.4.1.

7. The microbial fuel cell of claim 1, wherein the growth medium comprises a single carbon source.

8. The microbial fuel cell of claim 7, wherein the single carbon source is selected from the group consisting of succinate, propionate and glucose.

9. The microbial fuel cell of claim 1, wherein the growth medium is limited for a fixed nitrogen source.

10. The microbial fuel cell of claim 1, wherein the anode is selected from the group consisting of carbon and graphite.

11. The microbial fuel cell of claim 1, wherein the oxidation catalyst comprises chlorplatinate and titanium dioxide.

12. The microbial fuel cell of claim 1, wherein the anode is optically transparent.

13. The microbial fuel cell of claim 12, wherein the anode comprises glass coated with a conductant.

14. The microbial fuel cell of claim 14, wherein the conductant is a member selected from the group consisting of tin oxide, indium tin oxide, titanium dioxide and mixtures thereof.

15. The microbial fuel cell of claim 1, wherein the cathode comprises a material selected from the group consisting of carbon and graphite.

16. The microbial fuel cell of claim 1, wherein the cathode is an air cathode that is permeable to oxygen gas.

17. The microbial fuel cell of claim 1, wherein the cathode is permeable to nitrogen gas.

18. The microbial fuel cell of claim 1, wherein the oxidation catalyst is platinum.

19. The microbial fuel cell of claim 1, wherein the reduction-catalyst is selected from the group consisting of platinum titanium dioxide mixture, co-tetra-methyl phenylporphyrin (CoTMPP) and iron phthalocyanine (FePc).

20. The microbial fuel cell of claim 1, wherein reaction chamber allows passage of wavelengths of light ranging from about 600 nanometers to about 1000 nanometers.

21. A method for producing electricity in a light-powered microbial fuel cell, comprising the steps of:
(a) providing a light-admitting reaction chamber containing in operative arrangement a photosynthetic organism in a growth medium, an anode, a cathode in electrical and fluid communication with the anode, Wherein the light-admitting reaction chamber is a single chamber in which both anodic and cathodic reactions occur, and wherein the anode includes an oxidation catalyst disposed thereon and the cathode includes a reduction catalyst disposed thereon that is accessible to oxygen gas; and
(b) exposing the microbial fuel cell to light.

22. The method of claim 21, wherein the light-admitting reaction chamber comprises a material selected from the group consisting of glass, quartz and plastic.

23. The method of claim 21, wherein the light-admitting reaction chamber further comprises a vent for emitting a gas produced within the chamber.

24. The method of claim 21, wherein the photosynthetic organism is a member selected from the group consisting of Rhodospirillaceae, Acetobacteraceae, Bradyrhizobiaceae, Hyphomicrobiaceae, Rhodobiaceae, Rhodobacteraceae, Rhodocyclaceae and Comamonadaceae.

25. The microbial fuel cell of claim 23, wherein the Rhodobacteraceae is Rhodobacter sphaeroides.

26. The method of claim 24, wherein the Rhodobacteraceae is Rhodobacter sphaeroides strain 2.4.1.

27. The method of claim 21, wherein the growth medium comprises a single carbon source.

28. The method of claim 27, wherein the single carbon source is selected from the group consisting of succinate, propionate and glucose.

29. The method of claim 28, wherein the growth medium is limited for a fixed nitrogen source.

30. The method of claim 21, wherein the anode comprises a material selected from the group consisting of carbon and graphite.

31. The method of claim 21, wherein the anode is optically transparent.

32. The method of claim 31, wherein the anode comprises glass coated with a conductant.

33. The method of claim 32, wherein the conductant is selected from the group consisting of tin oxide, indium tin oxide, titanium dioxide and mixtures thereof.

34. The method of claim 21, wherein the oxidation catalyst comprises chloroplatinate and titanium dioxide.

35. The method of claim 21, wherein the cathode comprises a material selected from the group consisting of carbon and graphite.

36. The method of claim 21, wherein the cathode is an air cathode that is permeable to oxygen gas.

37. The method of claim 21, wherein the cathode is permeable to nitrogen gas.

38. The method of claim 21, wherein the oxidation catalyst is platinum.

39. The method of claim 21, wherein the reduction catalyst is selected from the group consisting of platinum titanium dioxide mixture, co-tetra-methyl phenylporphyrin (CoTMPP) and iron phthalocyanine (FePc).

40. The method of claim 21, wherein the light-admitting reaction chamber allows passage of wavelengths of light ranging from about 600 nanometers to about 1000 nanometers.
